(19) United States
(12) Patent Application Publication
(10) Pub. No.: US 2015/0040102 A1
(43) Pub. Date: Feb. 5, 2015

(54) SYSTEM AND METHOD FOR SOFTWARE INTEROPERABILITY

(71) Applicant: FP COMPLETE, Encinitas, CA (US)

(72) Inventor: Andy Adams-Moran, Portland, OR (US)

(21) Appl. No.: 14/339,569

(22) Filed: Jul. 24, 2014

Related U.S. Application Data
(60) Provisional application No. 61/860,607, filed on Jul. 31, 2013.

(51) Int. Cl. G06F 9/44

(52) U.S. Cl. CPC G06F 8/315
USPC 717/116

(57) ABSTRACT

A software interoperability system includes at least one processor, at least one computer-readable tangible storage device, and program instructions stored on the at least one storage device for execution by the at least one processor. The program instructions include first program instructions configured to map a program operation of a first programming type to a programming operation of a second programming type. The program instructions further include second program instructions configured to generate a first programming type representation of an object associated with the program operation of the second programming type based on the map. The program instructions further include third program instructions configured to effect an invoked instance of the first programming type representation via an interface associated with the second program type.

### CROSS-REFERENCE TO RELATED APPLICATIONS

This application claims priority to U.S. Provisional Patent Application No. 61/860,607 filed on Jul. 31, 2013, which is incorporated by reference herein in its entirety.

### BACKGROUND

Different programming languages exist for writing computer software. For example, object-oriented programming languages focus on objects and data associated with the objects while functional programming languages focus on calculations or functions. While there are applications in which it may be beneficial to utilize an object-oriented programming language such as Java or a functional programming language such as Haskell, there are also applications in which it may be beneficial to use two different languages, such as Java and Haskell, in combination.

Java includes tools to enable software interoperability. For example, the Java Native Interface (“JNI”) enables Java code running on a Java Virtual Machine to be embedded in applications written in other programming languages such as Haskell, provided the other languages can interoperate with the C programming language which is the language in which the JNI is written and targets natively. However, using the JNI is tedious and time consuming, especially from a programming language other than C. Furthermore, using the JNI is error prone. Specifically, the Application Programming Interface (“API”) provided is low-level and provides little to no protection to the client of the API.

### SUMMARY

A software interoperability system includes at least one processor, at least one computer-readable tangible storage device, and program instructions stored on the at least one storage device for execution by the at least one processor. The program instructions include first program instructions configured to map a program operation of a first programming type to a programming operation of a second programming type. The program instructions further include second program instructions configured to generate a first programming type representation of an object associated with the program operation of the second programming type based on the map. The program instructions further include third program instructions configured to effect an invoked instance of the first programming type representation via an interface associated with the second program type.

A method for facilitating software interoperability includes the step of a computer receiving a Haskell request to perform a Java program operation. The method further includes the step of a computer mapping the Haskell request to a Java object associated with the Java program operation. The method further includes the step of a computer generating a Haskell representation of the Java object. The method further includes the step of a computer effecting an invoked instance of the Haskell representation of the Java object via a Java Native Interface.

A computer program product for enabling software interoperability includes at least one computer-readable tangible storage device and program instructions stored on the at least one storage device. The program instructions include first program instructions configured to map a Haskell request to perform a Java program operation to a Java object associated with the requested program operation. The program instructions further include second program instructions configured to generate a Haskell representation of the Java object based on the map. The program instructions further include third program instructions configured to effect an invoked instance of the Haskell representation of the Java object via a Java Native Interface.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates a block diagram of an example system for facilitating software interoperability.

FIG. 2A illustrates an example configuration for implementing an example system for facilitating software interoperability.

FIG. 2B illustrates an example configuration for implementing an example system for facilitating software interoperability.

FIG. 2C illustrates an example configuration for implementing an example system for facilitating software interoperability.

FIG. 2D illustrates an example configuration for implementing an example system for facilitating software interoperability.

FIG. 3 illustrates a block diagram of an example server-side system for facilitating software interoperability.

FIG. 4A illustrates a block diagram of an example client-side system for facilitating software interoperability.

FIG. 4B illustrates a block diagram of an example client-side system for facilitating software interoperability.

FIG. 5 is a flow chart illustrating an example method for facilitating software interoperability.

FIG. 6 is a block diagram of an example computing system for implementing an example system for facilitating software interoperability.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

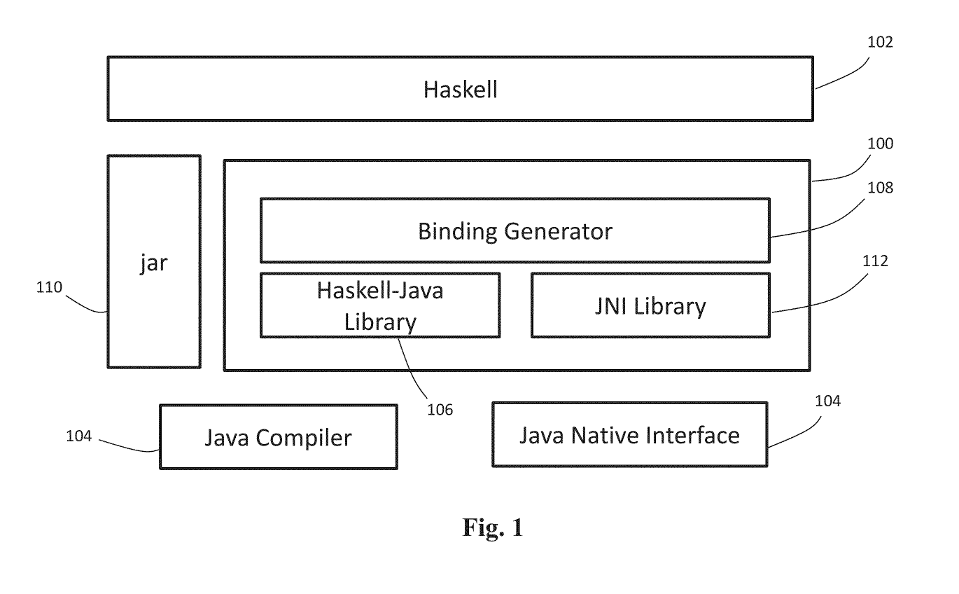

FIG. 1 illustrates a block diagram of an example system 100 for facilitating software interoperability. System 100 acts as an interface between a Haskell program 102 and a Java compiler 104 during compile time and also acts as an interface between Haskell program 102 and a Java Native Interface 104 (“JNI”) during run-time. System 100 enables a user or a programmer to efficiently import Java classes into Haskell program 102 with strong type separation and minimal marshaling.

It should be appreciated that, although system 100 is described in the example embodiments as facilitating interoperability between Haskell and Java, system 100 may similarly be applied to facilitate interoperability between other software programming languages such as C, C#, C++, Objective-C, and so on.

System 100 includes a Haskell-Java library 106, or module, configured to map a Haskell request to perform a Java program operation to a Java object associated with the requested program operation. For example, Haskell program 102 may request to load a Java Virtual Machine (“JVM”), to create a reference to a Java class, to create a reference to a method, to invoke a class, or to invoke a method, and so on. In one example, Haskell program 102 may make multiple related requests, or a pattern of requests. Accordingly, Haskell-Java library 106 may be configured to map the multiple requests, or the pattern of requests, to a Java object associated with the requests.

In one example, Haskell-Java library 106 includes a Java Generics module configured to map a generic Haskell request to a Java Generics method. Specifically, a Java Generics module extends the kinds of labels supported by Haskell-Java library 106 to allow for parameterized labels where a parameter directly corresponds to a generic parameter in Java.

System 100 includes a binding generator 108 configured to generate a Haskell representation of the Java object based on the map. Specifically, binding generator 108 is automatically triggered during compile time if Haskell program 102 incorporates a Java class. Once triggered, binding generator 108 is configured to communicate with Haskell-Java interface 106 to initiate mapping of all Haskell requests to perform a Java program operations to Java objects. Based on the classes imported by Haskell program 102, binding generator 108 is configured to generate type families and type family instances as Haskell representations. This generated Haskell code is saved as a Java Archive (“jar”) file 110. The Haskell jar file 110 includes a Haskell label corresponding to each referenced Java object, a Haskell instance of a type-family corresponding to each method of each object, and an instance of an invoker class for each method of each object. This enables a user creating Haskell program 102 to create instances of Java objects and invoke their methods in a type-safe and type-inferred manner.

System 100 further includes a JNI library 112 configured to effect an invoked instance of a Haskell representation of a Java object via JNI 104. Specifically, JNI library 112 serves as a low level interface to JNI 104. Operations provided by JNI 104 are supported by JNI library 112. For example, JNI library 112 supports looking up, creating, and destroying references to classes and methods in a JVM, invoking methods in the JVM, creating and manipulating Java primitives, and so on.

In one example, JNI library 112 is monomorphic in that it treats all Java objects as unresolved foreign pointers. Specifically, JNI library 112 does not attempt to distinguish between two different Java classes, and therefore will allow a programmer to attempt erroneous calls. This is in contrast to Haskell-Java library 106 which is type-safe and issues a type error for an invocation that would lead to a run-time error.

JNI library 112 interfaces with JNI 104 with minimal marshaling and un-marshaling. Specifically, C native types are used where appropriate. In addition, reference types are pointers directly into a JVM heap. In one example, reference types are wrapped by Haskell's foreign pointer abstraction to prevent space leaks and early garbage collection.

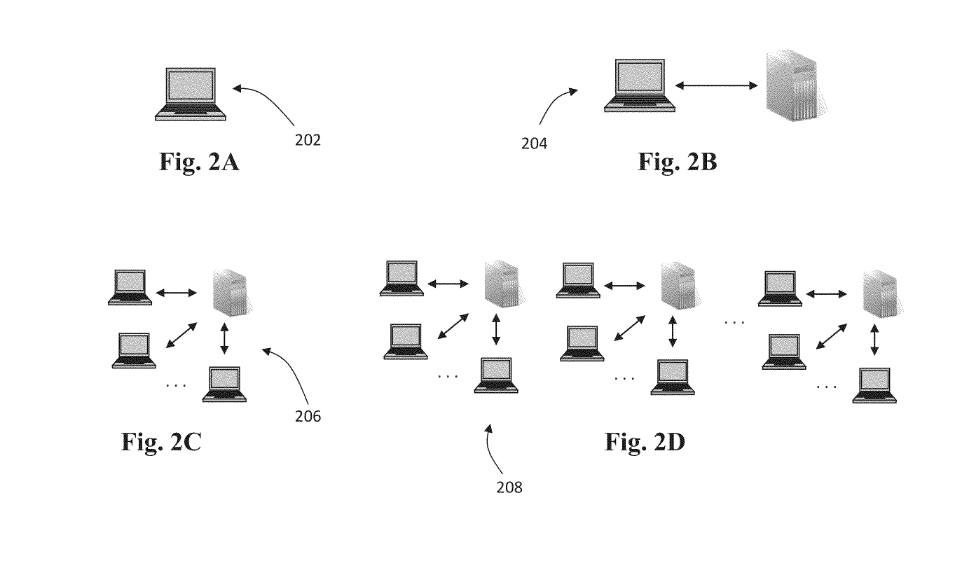

In one example, system 100 may be implemented on a single computer. In another example, one or more instances of system 100 may be implemented on two or more distributed computers. FIGS. 2A-2D illustrate various example configurations for implementing an example system for facilitating software interoperability. FIG. 2A illustrates an example single computer configuration 202 for implementing a system for facilitating software interoperability.

FIGS. 2B-2D illustrate example distributed configurations for implementing a system for facilitating software interoperability. In the example configurations, the system is distributed over one or more client computers and one or more servers. Specifically, FIG. 2B illustrates an example client-server configuration 204 for implementing a system for facilitating software interoperability in which a single client computer communicates with a single server. FIG. 2C illustrates an example application server configuration 206 for implementing a system for facilitating software interoperability in which multiple client computers communicate with a single server. FIG. 2D illustrates an example multiple application server cluster configuration 208 for implementing a system for facilitating software interoperability in which multiple client computers communicate with multiple application servers.

Distributed configurations for implementing a system for facilitating software interoperability offer a user or a programmer the same perceived functionality. However, modifying the configuration to allow for distributed deployment allows the system to be more scalable and extensible and enables the system to be more efficiently integrated with enterprise deployment and applications servers such as JBoss and Websphere.

In an example distributed configuration, a system for facilitating software interoperability is broken up into a client side system and a server side system that work together to provide a user or a programmer with the same functionality as provided by a single computer implementation of the system.

The client and server systems share generated Haskell jar files. The client and server systems also share a remote procedure call (“RPC”) transport configuration (such as sockets, JSON, websockets, and so on) as well as RPC serialization. Functionally, instead of calling to a JVM directly, a client side system makes an RPC to a server system. In one example, a client-side system and a server-side system communicate using a secure communication protocol such as TLS, SSL, and so on. A client-side system communicates with a server-side system to send an invocation request and wait for a reply. The server-side system listens for a request, makes the corresponding JNI invocation, and sends the result back to the client-side system.

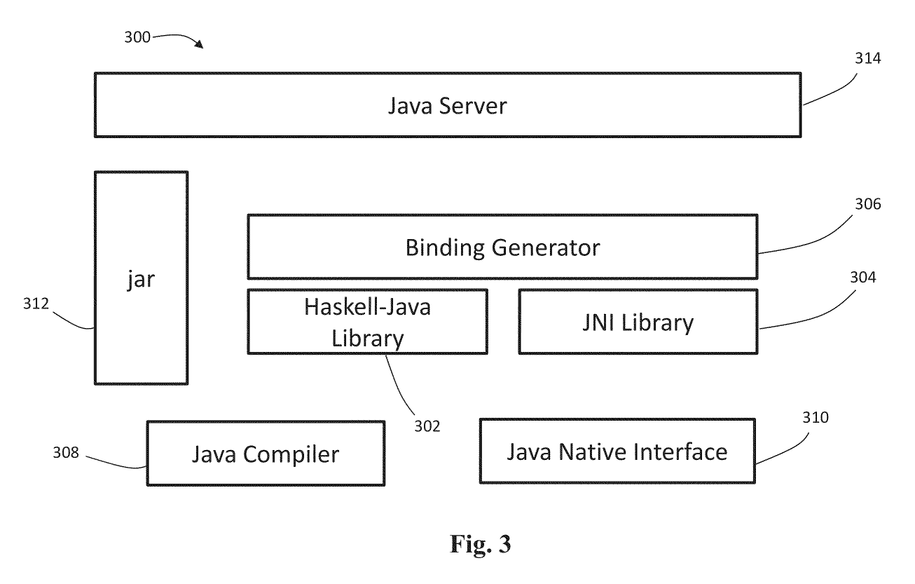

FIG. 3 illustrates a block diagram of an example server-side system 300 for facilitating software interoperability. Similar to a single computer configuration described in FIG. 1, a server-side system 300 includes a Haskell-Java library 302, a JNI library 304, and a binding generator 306 for interfacing with a Java compiler 308 and a JNI 310, and for generating a Haskell jar file 312. However, rather than receiving requests directly from a Haskell user program, server-side system 300 includes a Java server 314 for receiving requests from a client-side system. Thus, Java server 314 is configured serve as an interface between a client-side system and server-side system 300. Java server 314 is also configured to communicate results back to a client-side system.

A client-side system may be implemented to place the burden of translating a request down to the JNI either on the client side or on the server side. Specifically, a client-side system may make RPC calls that correspond to Java API calls while a server-side system may be burdened with translating the call down to the JNI. Alternatively, a client-side system may be burdened with translating a call down to the JNI before making the RPC.

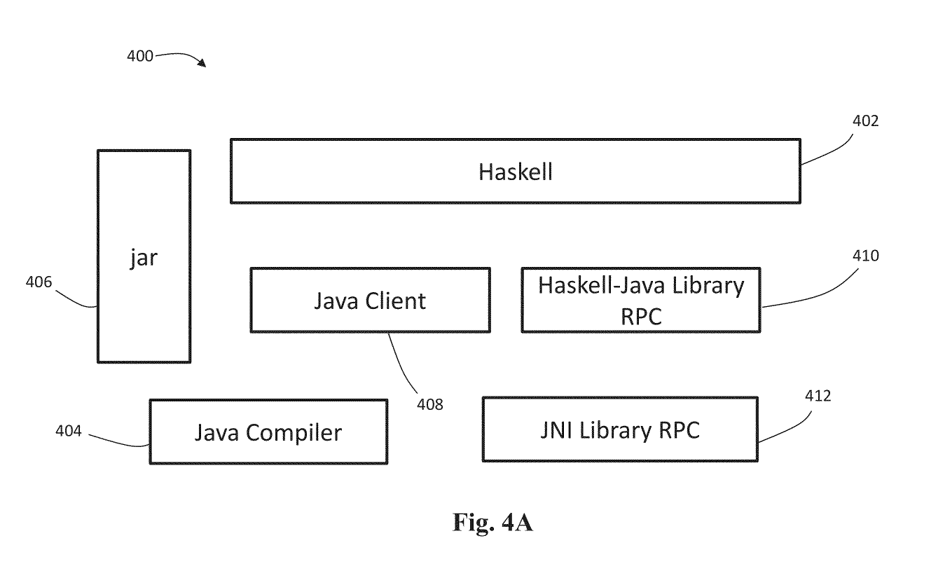

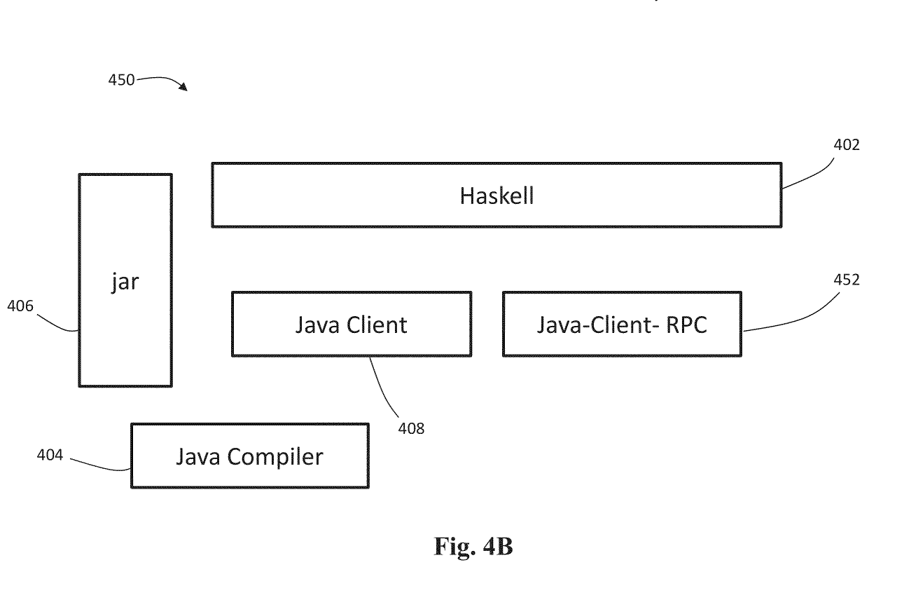

FIG. 4A illustrates a block diagram of an example client-side system 400 for facilitating software interoperability in which the burden of translating a request down to the JNI is placed on client-side system 400. Similar to the single computer configuration of a system for facilitating software interoperability described in FIG. 1, client-side system 400 acts as an interface between a Haskell program 402 and a Java compiler 404 during compile time and also acts as an interface between Haskell program 402 and a JNI during run-time.

Client-side system 400 also utilizes a generated Haskell jar file 406 although client-side system 400 further includes a Java Client 408 which assumes some functionality that would otherwise be generated by a binding generator and included in Haskell jar file 406. Specifically, Java client 408 invokes methods and constructors and also gets and sets fields of Java classes in scope. Client-side system 400 further includes a Haskell-Java library RPC 410 and a JNI Library RPC for making remote procedure calls to a Haskell-Java library and a JNI library, respectively, on server-side system 300.

FIG. 4B illustrates a block diagram of an example client-side system 450 for facilitating software interoperability in which the burden of translating a request down to the JNI is placed on a server-side system. In this example, a Java Client RPC 452 makes calls to server-side system 300 to invoke Java methods instead of invoking methods on the client-side. Specifically, specialized encoding is generated for a loaded class, rather than specialized for the JNI as is generated by client-side system 400. As a result, burden is shifted to the server-side.

In one example, a client-side and a server-side system are tightly coupled when implemented in a client-server configuration in that client-side system execution triggers server-side system startup. Similarly, the server-side system automatically shuts down after a client-side system disconnects or completes execution. Thus, when implemented as an application server, the client and server process is decoupled so that multiple clients may connect with a server.

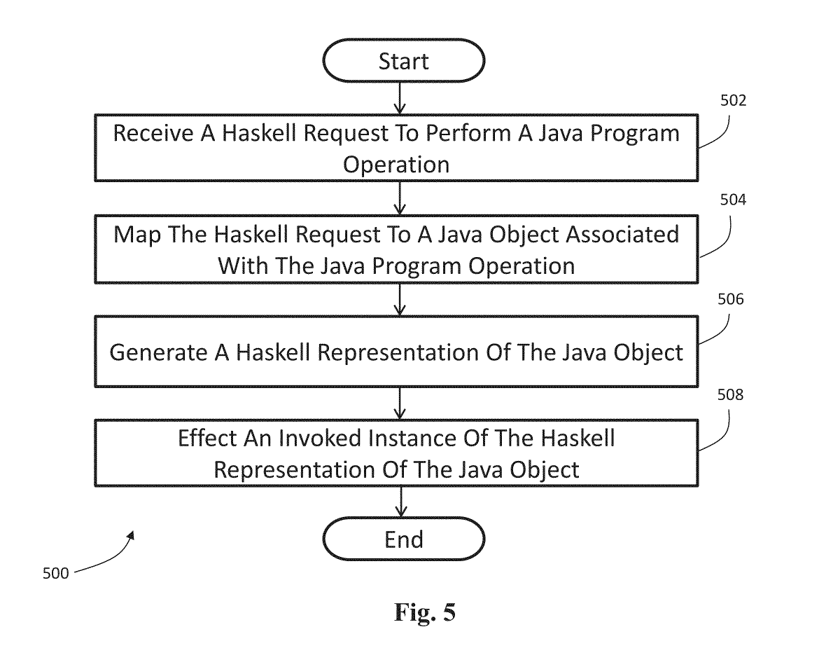

FIG. 5 a flow chart illustrating an example method 500 for facilitating software interoperability. At step 502, a computer receives a Haskell request to perform a Java program operation. For example the computer may receive a request to load a Java Virtual Machine, to create a reference to a class, to create a reference to a method, to invoke a class, to invoke a method, and so on. At step 504, a computer maps the Haskell request to a Java object associated with the Java program operation. In one example, the computer maps a group of Haskell program requests to one or more Java objects.

At step 506, a computer generates a Haskell representation of the Java object. In one example, the computer generates a Haskell representation of the Java object by generating a Java archive file comprising Haskell program code configured to implement the object. In one example, the computer generates a type-safe Haskell representation of the Java object. For example, the computer generates a Haskell label corresponding to the Java object, a Haskell instance of a type-family corresponding to each method of the object, and an instance of an invoker class for each method of the object. At step 508, a computer effects an invoked instance of the Haskell representation of the Java object via a JNI interface.

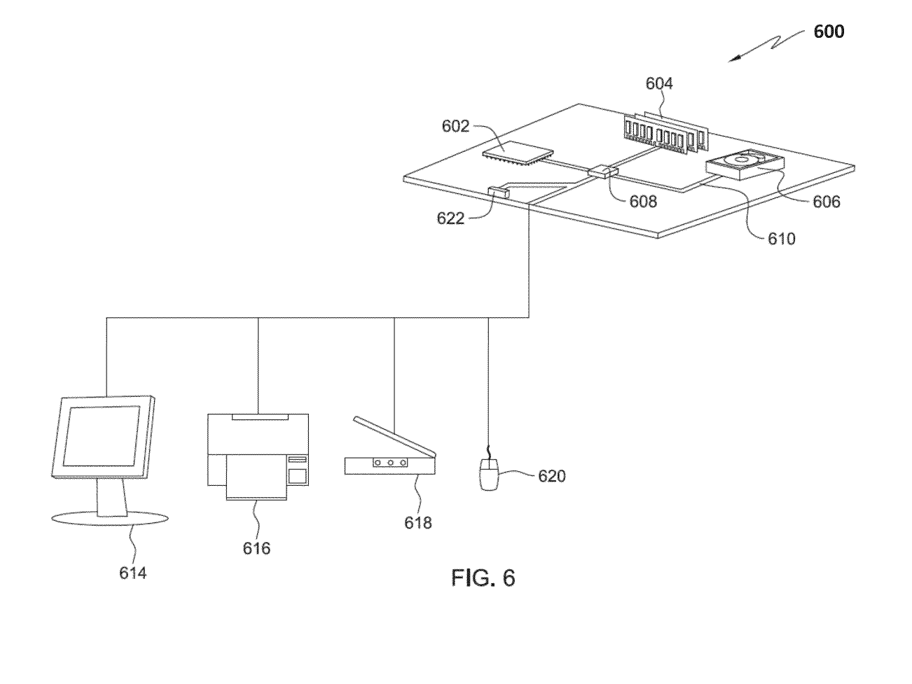

FIG. 6 is a block diagram of an example computing system 600 for implementing an example system for facilitating software interoperability. The example computing system 600 is intended to represent various forms of digital computers, including laptops, desktops, handheld computers, tablet computers, servers, and other similar types of computing devices. As shown, computing system 600 includes a processor 602, memory 604, a storage device 606, and a communication port 608, operably connected by an interface 610 via a bus 612.

Processor 602 processes instructions, via memory 604, for execution within computing system 600. In an example embodiment, multiple processors along with multiple memories may be used.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 604 or storage device 606.

Computing system 600 may be coupled to one or more input and output devices such as a display 614, a printer 616, a scanner 618, and a mouse 620.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A software interoperability system comprising at least one processor, at least one computer-readable tangible storage device, and program instructions stored on the at least one storage device for execution by the at least one processor, the program instructions comprising:
first program instructions configured to map a program operation of a first programming type to a programming operation of a second programming type;
second program instructions configured to generate a first programming type representation of an object associated with the program operation of the second programming type based on the map; and
third program instructions configured to effect an invoked instance of the first programming type representation via an interface associated with the second program type.

2. The software interoperability system of claim 1, wherein the first programming type comprises Haskell and wherein the second programming type comprises Java.

3. The software interoperability system of claim 2, wherein the interface associated with the second program type comprises a Java Native Interface

4. The software interoperability system of claim 2, wherein the first programming type representation of the object is a Java archive file comprising Haskell program code configure to implement the object.

5. The software interoperability system of claim 1, wherein the first program instructions are further configured to map a plurality of program operations of a first programming type to one or more program operations of a second programming type.

6. The software interoperability system of claim 1, wherein a programming operation comprises at least one of loading a Java Virtual Machine, creating a reference to a class, creating a reference to a method, invoking a class, and invoking a method.

7. The software interoperability system of claim 1, further comprising fourth program instructions configured to map a generic program operation of the first programming type to the second programming type.

8. A method for facilitating software interoperability, the method comprising the steps of:
a computer receiving a Haskell request to perform a Java program operation;
a computer mapping the Haskell request to a Java object associated with the Java program operation;
a computer generating a Haskell representation of the Java object; and
a computer effecting an invoked instance of the Haskell representation of the Java object via a Java Native Interface.

9. The method of claim 8, wherein the step of the computer generating a Haskell representation of the Java object comprises the computer generating a Java archive file comprising Haskell program code configured to implement the object.

10. The method of claim 8, wherein the step of the computer mapping the Haskell request to a Java object associated with the program operation comprises the computer mapping a plurality of Haskell program requests to one or more Java objects.

11. The method of claim 8, wherein the step of the computer receiving a Haskell request to perform a Java program operation comprises the computer receiving a Haskell request to perform at least one of loading a Java Virtual Machine, creating a reference to a class, creating a reference to a method, invoking a class, and invoking a method.

12. The method of claim 8, wherein the step of a computer generating a Haskell representation of the Java object comprises the computer generating a type-safe Haskell representation of the Java object.

13. The method of claim 12, wherein the step of the computer generating a type-safe Haskell representation of the Java object comprises the computer generating a Haskell label corresponding to the Java object, generating a Haskell instance of a type-family corresponding to each method of the object, and generating an instance of an invoker class for each method of the object.

14. A computer program product for enabling software interoperability, the computer program product comprising at least one computer-readable tangible storage device and program instructions stored on the at least one storage device, the program instructions comprising:
first program instructions configured to map a Haskell request to perform a Java program operation to a Java object associated with the requested program operation;
second program instructions configured to generate a Haskell representation of the Java object based on the map; and
third program instructions configured to effect an invoked instance of the Haskell representation of the Java object via a Java Native Interface.

15. The computer program product of claim 14, wherein the Haskell representation of the Java object is a Java archive file comprising Haskell program code configure to implement the object.

16. The computer program product of claim 14, wherein the first program instructions are further configured to map a pattern of Haskell program requests to one or more Java objects.

17. The computer program product of claim 14, wherein a programming operation comprises at least one of loading a Java Virtual Machine, creating a reference to a class, creating a reference to a method, invoking a class, and invoking a method.

18. The computer program product of claim 14, further comprising fourth program instructions configured to map a generic Haskell program operation to a generic Java program operation.

19. The computer program product of claim 14, wherein the second program instructions are further configured to generate a type-safe Haskell representation of the Java object.

20. The computer program product of claim 19, wherein the second program instructions are further configured to generate a Haskell label corresponding to the Java object, a Haskell instance of a type-family corresponding to each method of the object, and an instance of an invoker class for each method of the object.
